(19) United States
(12) Patent Application Publication
(10) Pub. No.: US 2010/0188040 A1
(43) Pub. Date: Jul. 29, 2010

(54) PLUG-IN NON-HYBRID-ELECTRIC VEHICLE FOR INCREASED FUEL EFFICIENCY

(75) Inventor: Dennis Craig Reed, Dexter, MI (US)

Correspondence Address: ALLEMAN HALL MCCOY RUSSELL & TUTTLE, LLP, 806 S.W. BROADWAY, SUITE 600, PORTLAND, OR, 97205, US

(73) Assignee: Ford Global Technologies, LLC, Dearborn, MI (US)

(21) Appl. No.: 12/361,214

(22) Filed: Jan. 28, 2009

(51) Int. Cl. H02J 7/00

(52) U.S. Cl. 320/107; 320/134

(57) ABSTRACT

A system for a vehicle including an internal combustion engine configured to provide the exclusive source of motive power to the vehicle, an energy storage device coupled to an electrical system, and a charging interface coupled to the energy storage device, the charging interface configured to attach to an external charging device.

### BACKGROUND AND SUMMARY

Oil has been steadily increasing in price due to the dwindling worldwide supply. In recent years vehicle manufactures have become increasingly focused on improving vehicles fuel economy due in part to the rising fuel prices as well as a number of environmental concerns. Many attempts have been made to utilize regenerative technology in hybrid vehicles to capture some of the mechanical power losses, in the form of stored energy, which may be used to provide motive power as well as electrical power to various systems within the vehicle.

In U.S. Pat. No. 5,670,830 a hybrid electric vehicle is provided. The vehicle attempts to decrease fuel consumption in the vehicle via a fuel use limiter, decreasing the vehicles reliance on the internal combustion engine, reducing emissions and increasing gas mileage. Specifically, the fuel use limiter may measure various parameters of the vehicle, and from these measurements operational characteristics of the vehicle may be established to limit fuel consumption in the vehicle.

The inventors have recognized several problems with the above approach. Monetary saving from the increased fuel economy in a hybrid vehicle may not justify the substantial increase in the price of the vehicle due to the cost of the additional systems, components, etc., in the vehicle, such as rechargeable batteries. Furthermore, the additional systems and components may increase the complexity of the vehicle, ultimately leading to increased repair and servicing costs. Therefore, many vehicle manufactures are seeking alternate ways to increase the fuel economy of vehicles without drastically increasing the price of the vehicle, increasing customer appeal as well as decreasing the environmental footprint of the vehicle.

As such, in one approach, a system is provided for a vehicle including an internal combustion engine configured to provide the exclusive source of motive power to the vehicle, an energy storage device coupled to an electrical system, and a charging interface coupled to the energy storage device, the charging interface configured to attach to an external charging device. For example, the charging interface may be shaped as a plug configured to be plugged into a household outlet (110 VAC), or as a receptacle configured to receive such a plug. In another example, the charging interface may be shaped as a plug configured to be plugged into a higher voltage household appliance outlet (220 VAC), or as a receptacle configured to receive such a plug. Further still, the charging interface may be shaped to receive a specialized adaptor cable, where the opposite end of the cable is shaped as a household plug. Thus, in some examples, the charging interface provides both mechanically and electrical coupling to the external charging device.

In this way, a user may plug in a non-hybrid-electric vehicle for charging of the energy storage device while the vehicle is not in operation, and then this stored energy can be used during operation to reduce electrical power generation from the engine's alternator, for example. Such is possible even though the vehicle is not designed to be driven by electric motors. Thus, the vehicle's fuel economy may be increased, due to the decreased load on the engine, without significantly increasing the cost and/or complexity of the vehicle through complex regeneration systems, motor and transmission drive systems, etc. Furthermore, retrofit systems can be provided for retrofitting existing non-hybrid vehicles, if desired.

It should be understood that the background and summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic depiction of an internal combustion engine having a single combustion chamber.

FIG. 2 illustrates a schematic depiction of a vehicle with an external charging system.

FIGS. 3A-3B show illustrations of example external charging interfaces that may be included in the vehicle shown in FIG. 2.

FIG. 4 schematically illustrates the electrical system included in the vehicle shown in FIG. 2.

FIG. 5 illustrates an exemplary method used to store and transfer power within a vehicle.

### DETAILED DESCRIPTION

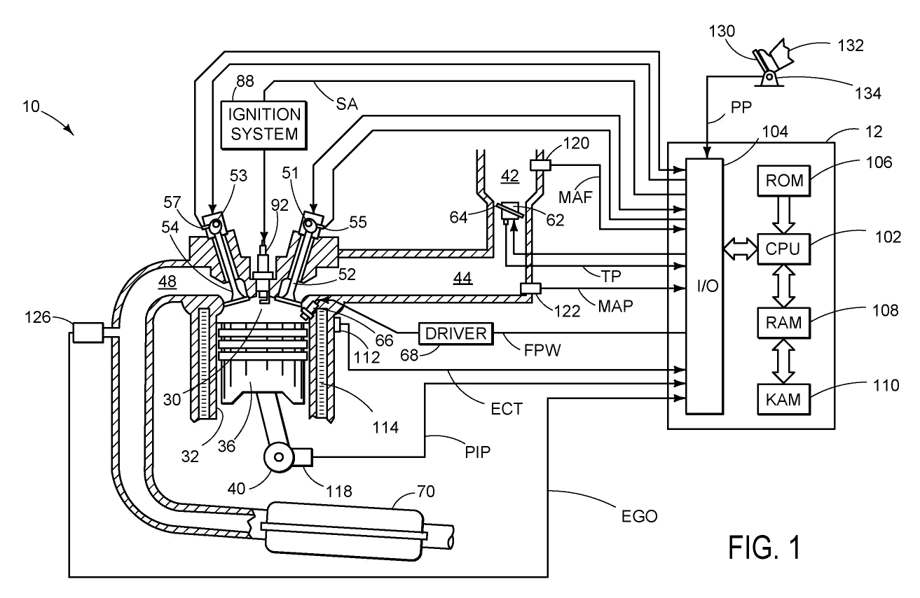

A system and method for a vehicle facilitating recharging of an energy storage device (e.g. battery) while the vehicle is at rest is disclosed herein. However, before describing the aforementioned system and method in detail, a suitable operating environment is described with regard to FIG. 1.

FIG. 1 is a schematic diagram showing one cylinder of multi-cylinder internal combustion engine 10. Engine 10 may be controlled at least partially by a control system including controller 12 and by input from a vehicle operator 132 via an input device 130. In this example, input device 130 includes an accelerator pedal and a pedal position sensor 134 for generating a proportional pedal position signal PP. Combustion chamber (e.g. cylinder) 30 of engine 10 may include combustion chamber walls 32 with piston 36 positioned therein. Piston 36 may be coupled to crankshaft 40 so that reciprocating motion of the piston is translated into rotational motion of the crankshaft. Crankshaft 40 may be coupled to at least one drive wheel of a vehicle via an intermediate transmission system. Further, a starter motor may be coupled to crankshaft 40 via a flywheel to enable a starting operation of engine 10.

Combustion chamber 30 may receive intake air from intake manifold 44 via intake passage 42 and may exhaust combustion gases via exhaust passage 48. Intake manifold 44 and exhaust passage 48 can selectively communicate with combustion chamber 30 via respective intake valve 52 and exhaust valve 54. In some embodiments, combustion chamber 30 may include two or more intake valves and/or two or more exhaust valves.

In this example, intake valve 52 and exhaust valves 54 may be controlled by cam actuation via respective cam actuation systems 51 and 53. Cam actuation systems 51 and 53 may each include one or more cams and may utilize one or more of cam profile switching (CPS), variable cam timing (VCT), variable valve timing (VVT) and/or variable valve lift (VVL) systems that may be operated by controller 12 to vary valve operation. In this example VCT is utilized. However, in other examples, alternate valve actuation systems may be used, such as electronic valve actuation (EVA) may be utilized. The position of intake valve 52 and exhaust valve 54 may be determined by position sensors 55 and 57, respectively.

Fuel injector 66 is shown coupled directly to combustion chamber 30 for injecting fuel directly therein in proportion to the pulse width of signal FPW received from controller 12 via electronic driver 68. In this manner, fuel injector 66 provides what is known as direct injection of fuel into combustion chamber 30. The fuel injector may be mounted in the side of the combustion chamber or in the top of the combustion chamber, for example. Fuel may be delivered to fuel injector 66 by a fuel system (not shown) including a fuel tank, a fuel pump, and a fuel rail. In some embodiments, combustion chamber 30 may alternatively or additionally include a fuel injector arranged in intake passage 44 in a configuration that provides what is known as port injection of fuel into the intake port upstream of combustion chamber 30.

Intake passage 42 may include a throttle 62 having a throttle plate 64. In this particular example, the position of throttle plate 64 may be varied by controller 12 via a signal provided to an electric motor or actuator included with throttle 62, a configuration that is commonly referred to as electronic throttle control (ETC). In this manner, throttle 62 may be operated to vary the intake air provided to combustion chamber 30 among other engine cylinders. The position of throttle plate 64 may be provided to controller 12 by throttle position signal TP. Intake passage 42 may include a mass air flow sensor 120 and a manifold air pressure sensor 122 for providing respective signals MAF and MAP to controller 12.

Ignition system 88 can provide an ignition spark to combustion chamber 30 via spark plug 92 in response to spark advance signal SA from controller 12, under select operating modes. Though spark ignition components are shown, in some embodiments, combustion chamber 30 or one or more other combustion chambers of engine 10 may be operated in a compression ignition mode, with or without an ignition spark.

Exhaust gas sensor 126 is shown coupled to exhaust passage 48 upstream of emission control device 70. Sensor 126 may be any suitable sensor for providing an indication of exhaust gas air/fuel ratio such as a linear oxygen sensor or UEGO (universal or wide-range exhaust gas oxygen), a two-state oxygen sensor or EGO, a HEGO (heated EGO), a NOx, HC, or CO sensor. Emission control device 70 is shown arranged along exhaust passage 48 downstream of exhaust gas sensor 126. Device 70 may be a three way catalyst (TWC), NOx trap, various other emission control devices, or combinations thereof. In some embodiments, during operation of engine 10, emission control device 70 may be periodically reset by operating at least one cylinder of the engine within a particular air/fuel ratio.

Controller 12 is shown in FIG. 1 as a microcomputer, including microprocessor unit 102, input/output ports 104, an electronic storage medium for executable programs and calibration values shown as read only memory chip 106 in this particular example, random access memory 108, keep alive memory 110, and a data bus. Controller 12 may receive various signals from sensors coupled to engine 10, in addition to those signals previously discussed, including measurement of inducted mass air flow (MAF) from mass air flow sensor 120; engine coolant temperature (ECT) from temperature sensor 112 coupled to cooling sleeve 114; a profile ignition pickup signal (PIP) from Hall effect sensor 118 (or other type) coupled to crankshaft 40; throttle position (TP) from a throttle position sensor; and absolute manifold pressure signal, MAP, from sensor 122. Engine speed signal, RPM, may be generated by controller 12 from signal PIP. Manifold pressure signal MAP from a manifold pressure sensor may be used to provide an indication of vacuum, or pressure, in the intake manifold.

Storage medium read-only memory 106 can be programmed with computer readable data representing instructions executable by processor 102 for performing the methods described below, as well as other variants that are anticipated but not specifically listed.

As described above, FIG. 1 shows only one cylinder of a multi-cylinder engine, and that each cylinder may similarly include its own set of intake/exhaust valves, fuel injector, spark plug, etc.

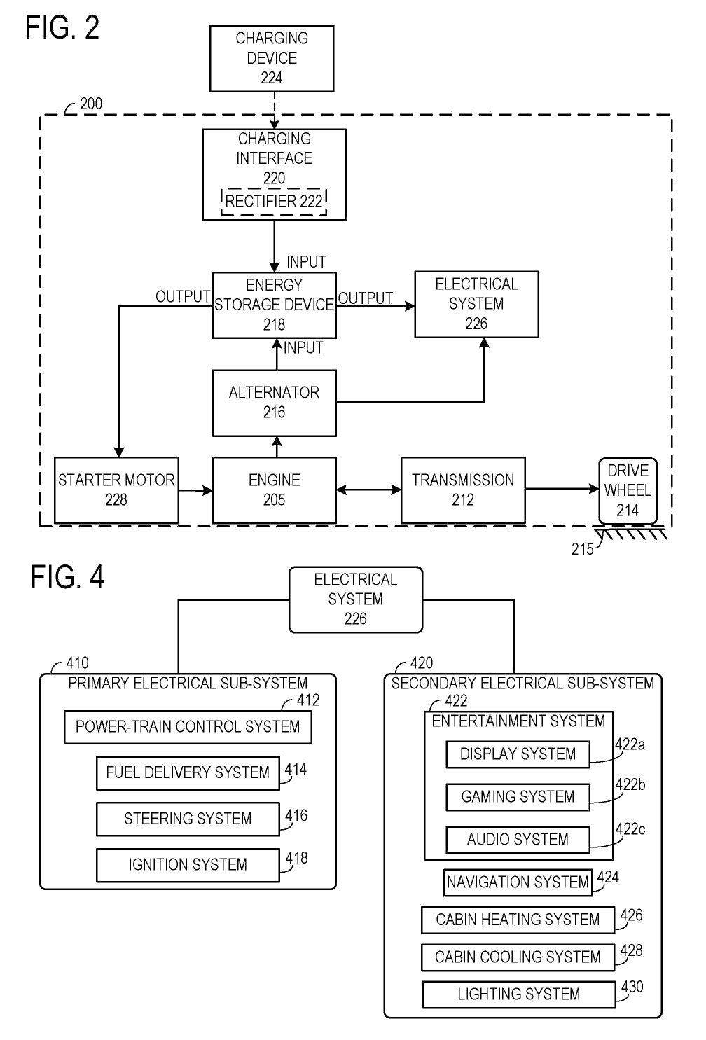

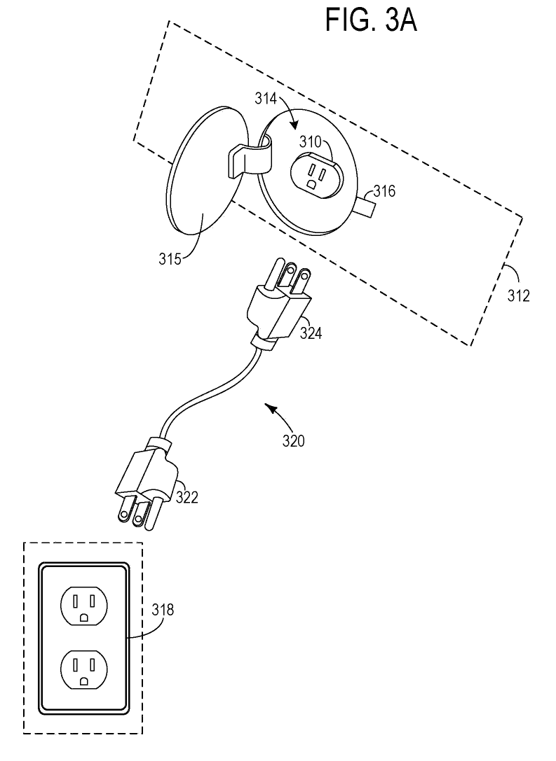

FIGS. 2-3B illustrate a number of systems within a vehicle adapted to facilitate energy transfer to an energy storage device from an external charging device while the vehicle is at rest, decreasing the vehicle reliance on an alternator and therefore the load on the engine during vehicle operation. Thus, the fuel efficiency of the vehicle may be increased without significantly increasing the price of the vehicle. Other benefits of the disclosed system are described in more detail herein.

FIG. 2 illustrates an automotive vehicle 200. In this example, the vehicle includes an internal combustion engine 205 providing the exclusive source of motive power for the vehicle. In some examples, internal combustion engine 10 may constitute engine 205. However, in other examples, another suitable internal combustion engine may be used. The internal combustion engine may be coupled to a transmission 212 configured to provide a speed-torque conversion (e.g. gear reduction) to the rotational output of the engine. Transmission 212 may be a manual transmission, automatic transmission, continuously variable transmission, or combinations thereof. Furthermore, additional components may be included in the transmission such as a torque convertor, and/or other gears such as a final drive unit, etc. The transmission is shown coupled to drive wheel 214, which is in contact with a road surface 215. Although a single drive wheel is shown, it can be appreciated that two or more drive wheels may be used to propel the vehicle.

An alternator 216 may be mechanically coupled to the drive shaft or other suitable component in the internal combustion engine 205. The alternator may be configured to convert rotational energy from the engine into electrical energy. A suitable alternator may be used, such as an alternator with a claw-pole field construction, a brushless alternator, a brush alternator, or a combination thereof. Additionally, a cooling system (not shown) may be provided for the alternator to draw thermal energy away from the component during periods of high temperature operation.

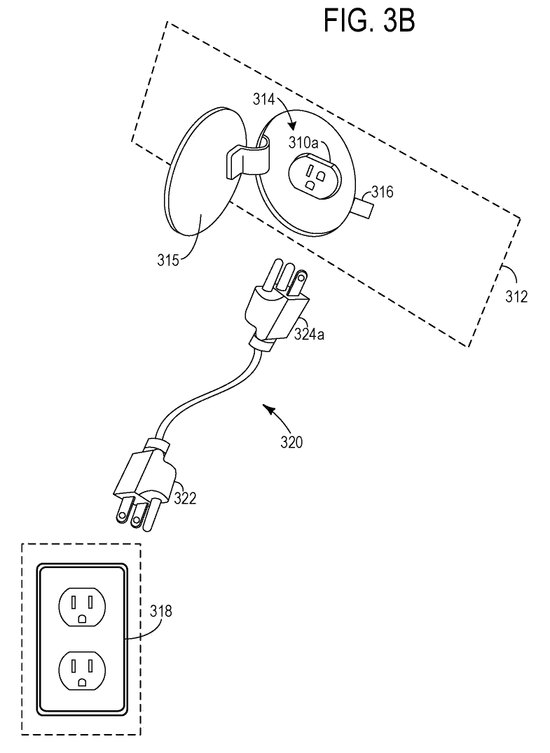

Further, in this example, alternator 216 may be electrically coupled to an energy storage device 218. In some examples, the energy storage device may include one or more batteries configured to chemically store energy and discharge electrical energy in the form of direct current (DC). The battery may be a suitable battery, such as a rechargeable lead acid battery, nickel-metal hydride batteries, lithium ion batteries, etc. It can be appreciated that a combination of the aforementioned batteries may be included in the energy storage device. To reduce cost a lead acid battery may be used. However, if the vehicle experiences a high electrical load during certain operating conditions, such as during engine operation, due to a large electrical system, a more stable rechargeable battery having a greater energy density may be used such as a nickel-metal hydride battery or a lithium ion battery. In other examples, the energy storage device may be a capacitor, a flywheel, a pressure vessel, etc. Further in this example, the alternator may be electrically coupled to an electrical system 226. The electrical system may include one or more electrically actuated components (e.g. the fuel injectors, valves, etc.), discussed in more detail herein with regard to FIG. 4. However in other examples, the energy storage device may provide the exclusive source of electrical power to the electrical system during engine and vehicle operation.

Further, in this example, the connection between energy storage device 218 and alternator 216 may form a first input of the energy storage device. Additionally, the energy storage device may be coupled to a charging interface 220, forming a second input. It can be appreciated that in other examples, the energy storage device may include additional inputs. The charging interface may be positioned proximate to the periphery of the vehicle, allowing a vehicle operator to easily access the charging interface and recharge the vehicle's energy storage device. Additional components may be included in or coupled to the charging interface such as a rectifier 222, transformer (not shown), etc. The rectifier may be configured to convert the alternating current (AC) current gathered from an external charging device 224, which may be fixed in a stationary location, into DC for charging. However, it can be appreciated that in alternate examples, the external charging device may include additional or alternate components depending on design parameters, such as the power requirements of the energy storage device, the type of current drawn from the external charging device, etc.

In some examples, charging interface 220 may be configured to electronically attach to external charging device 224. The charging interface may be attached and detached at the discretion of the vehicle operation. For example, a vehicle operator may couple the charging interface to an external charging device while the vehicle is at rest, allowing energy storage device 218 to be recharged. Various charging devices may be used, such as a standard wall outlet (110 volt alternating current (VAC)-120 VAC), discussed in greater detail herein with regard to FIGS. 3A-B. However, it can be appreciated that alternate suitable charging devices may be used having alternate voltage ranges, geometries, etc.

Further, in some examples, an indicator, which may be located on a dash (not shown) included in a cabin (not shown) of vehicle 200, may indicate to the operator of the vehicle when the state of charge (SOC) of the energy storage device has dropped below a threshold value, which may be predetermined. In this way, the operator of the vehicle may be prompted to periodically recharge the vehicle, decreasing the vehicle's reliance on the alternator.

Furthermore, energy storage device 218 may include two outputs. The energy storage device may be coupled to electrical system 226, forming the first output. Additionally, the energy storage device may be coupled to a starter motor 228, forming the second output. The starter motor may be configured to initiate rotation of a crankshaft, included in engine 205, to enable of starting operation of the engine, as previously discussed. However, the starter motor is not configured to recharge the energy storage device. In this example, the energy storage device does not provide motive power for the vehicle. The exclusive source of motive power for the vehicle is the internal combustion engine, as previously mentioned.

As will be described further herein, operation of the alternator may be adjusted to compensate for the additional storage received during recharging from the charging interface. Thus, even during some vehicle operation where the engine is operating, the alternator may be adjusted to reduce electrical power generation (including generating substantially no electrical power) so that the energy received from the external charging device can be used to power various components of the electrical system (such as a radio, navigation system, etc.), thus reducing fuel combusted to power those components. In this way, even in a non-hybrid vehicle, improved fuel economy can be obtained by implementing a plug-in concept for home charging, for example.

FIG. 3A illustrates an exemplary charging interface 310 which may be coupled to the energy storage device 218, illustrated in FIG. 2. In this example, charging interface 310 is similar to charging interface 220. However in other examples, charging interfaces, 220 and 310, may not be similar. The charging interface may be positioned on an exterior portion 312 of the vehicle. The exterior portion of the vehicle may be a body panel, vehicle door, deck lid, bumper, etc. In this example, the charging interface is not positioned within an engine compartment and is not adjacent to the engine compartment. Further, in this example, the charging interface is positioned within an exterior compartment 314, located at the exterior portion of the vehicle, facilitating easy access. The exterior compartment may include a door 315, which may also operate as an access panel reducing damage to the charging interface. Furthermore, in other examples, the geometry and/or size of the exterior compartment may be adjusted depending on the design parameters. The external compartment may also include a locking mechanism 316 configured to be mechanically or electronically actuated by a vehicle operator, preventing unwanted parties from accessing the charging interface.

In this example, the charging interface is a standardized three prong socket used in the United States. However, it can be appreciated that alternate suitable charging interfaces may be used, such as a plug which may be extendable, a socket and/or a prong having an alternate configuration, a wireless charging interface, European standardized plugs, etc. The charging interface may be configured to attach to a stationary wall outlet 318 or another suitable external charging device via an attachment device 320. In this example, the attachment device is an extension cord having a first and a second plug, 322 and 324 respectively. However, it can be appreciated that alternate suitable attachment devices adapted to couple to the charging interface as well as an external charging device (e.g. standard wall outlet), may be used in other examples. For example, a retractable attachment device may be integrated into the charging interface. Further in alternate examples, a wireless method of power transfer may be used to transfer power from the external charging device, which may be stationary, to the charging interface.

FIG. 3B shows an alternative charging interface 310a configured to receive an alternative plug 324a, where the alternative plug 324a is shaped to match the alternative charging interface 310a. In this example, the charging interface 310a is of a different shape than that of the charging source (wall outlet 318), and thus the plug 322 is shaped differently than 324a.

FIG. 4 illustrates a number of components, sub-systems, etc., which may be included in electrical system 226. However, it can be appreciated that additional or alternate components may be included in the electrical system. The electrical system may include a primary electrical sub-system 410. The primary electrical sub-system may include one or more components included in a power-train control system 412, a fuel delivery system 414, a steering system 416, and/or an ignition system 418. During operation of the vehicle power may be provided to the primary electrical sub-system enabling various functions of the vehicle (i.e. steering, fuel delivery, etc.).

The electrical system may further include a secondary electrical sub-system 420. The secondary electrical sub-system may include one or more components included in an entertainment system 422 including a display system 422a, a gaming system 422b, and/or an audio system 422c. The secondary electrical sub-system may further include a navigation system 424, a cabin heating system 426, a cabin cooling system 428, and/or a lighting system 430. It can be appreciated that alternate or additional electrical systems, devices, etc. may be included in the primary electrical sub-system or the secondary electrical sub-system.

The vehicle may operate in a variety of modes. In this example, the vehicle may operate in a Deceleration Fuel Shut-Off (DFSO) mode during various time intervals. The DFSO mode may include a mode in which no request for acceleration has been made in the vehicle and fuel delivery to the cylinders is substantially prevented, thereby inhibiting combustion (yet the engine still is spinning). Alternator 216 may be used to recharge the energy storage device 218, illustrated in FIG. 2, during DFSO without increasing the energy losses within the vehicle, thereby increasing the vehicle's efficiency.

Additionally, the vehicle may operation in a normal operation mode during various intervals. The normal operation mode may include operating the vehicle to produce motive power via combustion cycles of the engine, where air and fuel are combusted in the engine cylinders. In some examples, operation of alternator 216, illustrated in FIG. 2, may be reduced or inhibited during the normal operation mode, as opposed to DFSO, engine run up (e.g. start-up), and a shut down mode, in which the fuel injection and valve actuation is inhibited. It can be appreciated, that numerous modes of operation are possible and the aforementioned modes are exemplary in nature.

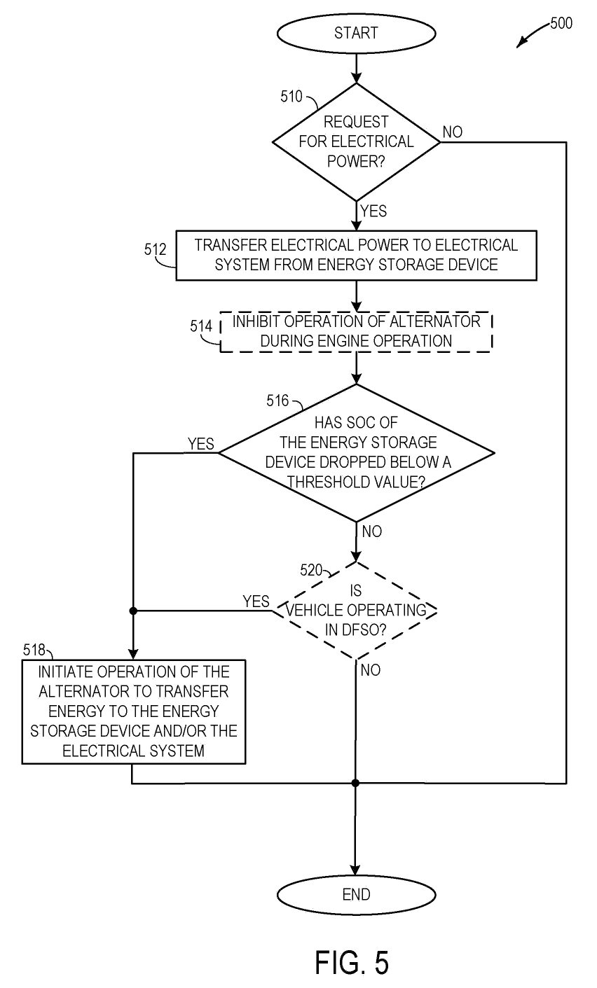

FIG. 5 illustrates a method 500 which may be used to store and distribute energy within a vehicle. Method 500 may be implemented during engine operation, while the vehicle is combusting air fuel and/or while the vehicle is traveling along a road surface. The method set forth in FIG. 5 may be implemented utilizing the system and components described above. However, it can be appreciated that the method set forth in FIG. 5 may be implemented utilizing other suitable components.

First at 510 it is determined if there is a request for electrical power in the vehicle. In some examples, the request for electrical power may come from one or more components included in an electrical system. In other examples, it may be determined if the engine is being operated within the vehicle and combusting air fuel (e.g. a normal mode of operation). If there is not a request for electrical power, the method may end or alternatively, in other examples, may return to the start.

However, if there is a request for electrical power, the method proceeds to 512 where electrical power is transferred to an electrical system within the vehicle from an energy storage device.

Next, the method may advance to 514 where operation of the alternator may be inhibited during engine operation, while the engine is combusting air fuel and/or while the vehicle is traveling along a road surface. In other examples, step 514 may be excluded from method 500.

Next, at 516, it is determined if the SOC of the energy storage device has dropped below a threshold value, which may be predetermined. Alternatively, in other examples, it may be determined if the energy stored in the device has reached or is approaching a threshold value. The threshold value may be determined utilizing at least one of the following parameters: electrical power consumption, electrical system load, engine temperature, and ambient temperature.

If the SOC of the energy storage device has dropped below a threshold value, the method then proceeds to 518 where operation of the alternator to transfer energy to the electrical system and/or the energy storage device is initiated. After 518, method 500 ends or alternatively, in other examples, returns to the start. However, if the SOC of the energy storage device has not dropped below a threshold value, the method then proceeds to 520 where it may be determined if the vehicle is operating in a DFSO mode. In other examples, step 520 may not be included in method 500. Alternatively or additionally it may be determined if the vehicle is in a shut-down mode. If the vehicle is in a DFSO mode, the method advances to 518. However, if the vehicle is not in a DFSO mode, the method ends or alternatively, in other examples, returns to the start. Method 500 allows the use of the alternator to be decreased, decreasing the load on the engine and consequently increasing the fuel economy of the vehicle.

Note that the example control and estimation routines included herein can be used with various engine and/or vehicle system configurations. The specific routines described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used. Further, the described acts may graphically represent code to be programmed into the computer readable storage medium in the engine control system.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system for a vehicle comprising:
an internal combustion engine configured to provide the exclusive source of motive power to the vehicle;
an energy storage device coupled to an electrical system; and
a charging interface coupled to the energy storage device, the charging interface configured to attach to an external charging device.

2. The system of claim 1 wherein the external charging device is fixed in a stationary location, and where the charging interface mechanically and electrically attaches to the external charging device.

3. The system of claim 2 wherein the external charging device is a standardized 110 volt-120 volt wall outlet.

4. The system of claim 1 wherein the charging interface includes a rectifier configured to convert alternating current from the external charging device to direct current.

5. The system of claim 1 further comprising an alternator, the alternator having an input mechanically coupled to the internal combustion engine and an output electrically coupled to the energy storage device and/or the electrical system.

6. The system of claim 5 wherein the energy storage device is a battery having a state of charge.

7. The system of claim 6 wherein operation of the alternator is initiated in response to a drop in the state of charge of the energy storage device below a threshold value and/or initiation of a Deceleration Fuel Shut-Off mode.

8. The system of claim 6 wherein the electrical system includes at least one or more components of in an ignition system, a control system, a steering system, and a fuel delivery system.

9. The system of claim 6 wherein the electrical system includes at least one of an entertainment system, a cabin heating system, a cabin cooling system, and a lighting system.

10. The system of claim 1 wherein the charging interface is positioned on an exterior portion of the vehicle accessible via an exterior body panel.

11. The system of claim 1 wherein the energy storage device is configured to provide the exclusive source of electrical power to the electrical system during engine and vehicle operation.

12. A system for a vehicle comprising:
an internal combustion engine configured to provide the exclusive source of motive power to the vehicle;
an energy storage device electrically coupled to a charging interface and an electrical system, the charging interface configured to electrically couple to a stationary charging device external to the vehicle; and
an alternator electrically coupled to the energy storage device and/or the electrical system.

13. The system of claim 12 wherein operation of the alternator is initiated when a state of charge of the energy storage device has dropped below a threshold value.

14. The system of claim 12 wherein the alternator is operated during a Deceleration Fuel Shut-Off mode, the Deceleration Fuel Shut-Off mode implemented during periods of engine and/or vehicle deceleration.

15. The system of claim 12 wherein the electrical system includes at least one of a entertainment system, a cabin heating system, a cabin cooling system, a lighting system, an ignition system, a control system, a steering system, and a fuel delivery system.

16. A method for operating a vehicle having an internal combustion engine, the internal combustion engine providing the exclusive source of motive power to the vehicle, the vehicle including an energy storage device having a charging interface electrically coupled to the energy storage device, the energy storage device coupled to an electrical system and a charging interface configured to attach to an external charging device, the method comprising:
transferring electrical energy from an energy storage device to the electrical system, responsive to a request for electrical power, during engine operation and while the vehicle is traveling along a surface, the request from one or more components included in the electrical system; and
inhibiting operation of the alternator during engine operation and while the vehicle is traveling along the surface and while the engine is combusting air and fuel.

17. The method according to claim 16 wherein the energy storage device is a battery having a state of charge.

18. The method according to claim 17 further comprising determining the state of charge of the energy storage device and initiating operation of the alternator when the state of charge had dropped below a threshold value.

19. The method according to claim 18 wherein the threshold value is predetermined.

20. The method according to claim 18 wherein the threshold value is determined based on at least one of the following parameters, engine temperature, ambient temperature, and electrical system load.
